(19) United States
(12) Patent Application Publication
(10) Pub. No.: US 2008/0071963 A1
(43) Pub. Date: Mar. 20, 2008

(54) Express card with extended USB interface

(75) Inventors: David Q. Chow, San Jose, CA (US); Sidney Young, Hsin Chu (TW); Charles C. Lee, Cupertino, CA (US); Abraham C. Ma, Fremont, CA (US); Ming-Shiang Shen, Hsin Chuang (TW)

Correspondence Address: BACON & THOMAS, PLLC, 625 SLATERS LANE, FOURTH FLOOR, ALEXANDRIA, VA, 22314, US

(73) Assignee: Super Talent Electronics Inc., San Jose, CA (US)

(21) Appl. No.: 11/979,103

(22) Filed: Oct. 31, 2007

Related U.S. Application Data
(63) Continuation-in-part of application No. 11/624,667, filed on Jan. 18, 2007.
(63) Continuation-in-part of application No. 10/746,935, filed on Dec. 23, 2003, now abandoned.
(63) Continuation-in-part of application No. 10/707,138, filed on Nov. 22, 2003, now abandoned.
(63) Continuation-in-part of application No. 11/864,696, filed on Sep. 28, 2007.

(51) Int. Cl. G06F 13/20; G06F 12/02

(52) U.S. Cl. 710/313; 711/103; 711/E12.008

(57) ABSTRACT

An ExpressCard having USB connection has a card case having two opposite first and second end portions and two opposite lateral portions. A card connector is formed at the first end portion of the card case and having a USB interface. Flash chips are implemented in the card case. A USB flash controller implemented in the card case and connected between the USB interface and the flash chips in order to provide a data access to the flash chips through the USB interface. A USB socket, in form factors of Mini-USB or Extended Mini-connector-type, is implemented in the card case and connected to the USB flash controller in order to provide a data access to the one or more flash chips therethrough. An extended Universal-Serial Bus (EUSB) host enters a suspend mode rather than poll an ExpressCard that is busy performing a memory or other operation, thereby saving power.

### RELATED APPLICATIONS

This application is a continuation-in-part (CIP) of U.S. patent application Ser. No. 11/624,667, filed Jan. 18, 2007, entitled “Electronic Data Storage Medium with Fingerprint Verification Capability”, which is a division of application Ser. No. 09/478,720, filed on Jan. 6, 2000, which has been petitioned claiming benefit of Continuation-In-Process status of one of inventor's earlier U.S. Patent application for “Integrated Circuit Card with Fingerprint Verification Capability”, U.S. application Ser. No. 09/366,976, filed Aug. 4, 1999, now issued as U.S. Pat. No. 6,547,130.

This application is also a CIP of U.S. patent application Ser. No. 10/746,935, filed Dec. 23, 2003, entitled “Dual Mode USB and PCI Express Device”,

This application is also a CIP of U.S. patent application Ser. No. 10/707,138, filed May 26, 2003, entitled “Express Card with On-Card Flash Memory with Shared Flash Memory Control Bus but Separate Ready Lines”.

This application is also a CIP of U.S. patent application Ser. No. 11/864,696, filed Sep. 28, 2007, entitled “Backward Compatible Extended-MLC USB Plug And Receptacle With Dual Personality”.

### BACKGROUND OF THE INVENTION

1. Field of the Invention

The present invention relates to an ExpressCard and, more particularly, to an ExpressCard having Extended universal serial bus (EUSB) connection port.

2. Description of Related Art

ExpressCard is developed by the Personal Computer Memory Card International Association (PCMCIA) in order to replace the interface standard “CardBus”. An ExpressCard can support two types of interfaces: a peripheral component interconnect (PCI) express serial interface and a USB interface, and the two interfaces are connected with a host through a connector of the ExpressCard.

In view of allowing the ExpressCard to connect to a computer or equipment with a standard USB socket, as shown in FIG. 1, the ExpressCard 11 has a connector 12 connected to a USB adapter 13 to thereby provide a standard USB connector 14 to the ExpressCard 11. Thus, the ExpressCard 11 can connect with a computer or equipment with a standard USB socket through the USB adapter 13, and is regarded as a standard USB product.

However, such a connection has a space limit in use due to the bulky USB adapter 13 and weakens the mechanical strength of the express card 11.

Furthermore, USB uses one pair of differential lines that are time-duplexed, or used for transmission in both directions, but at different times. This may limit performance when data needs to be sent in both directions at the same time. The current USB 2.0 standard provides that the host, such as the PC, controls the bus as the bus master, while USB devices plugged into the host act as slave devices. A USB controller on the host PC generates data transfer transactions and waits for USB devices to respond, either by transmitting requested data to the host, or by writing host data into the USB device's memory. Since memory on a USB device may be busy or slow, sometimes the host's request cannot be processed immediately. The host may send the request, then periodically poll the USB device to see whether the data is ready. Also, when the host is idle, the host may need to periodically poll the USB device to see if the USB device needs to transfer information to the host. This periodic polling may be used for other purposes as well, such as presence or removal of flash cards from the Card Reader device.

While polling is useful, since it allows the host to completely control the USB bus, power is consumed each time a packet is sent for polling. While this power is small, for low-power or battery-powered devices, the amount of power consumed may be significant and undesirable. Also, the USB device or host may otherwise be in a low-power sleep or suspend state, and have to wake up into a higher-power state to perform or respond to the polling. There may be significant time and energy required to wake up from the suspend or sleep state, and then to re-enter the suspend or sleep state once polling is done. Therefore, what is desired is a USB device and USB host that have lower power. A USB system that does not require polling is desirable. Bus protocols and transactions that avoid polling are desirable to be applied to USB to reduce energy consumed by polling.

Accordingly, it is desirable to provide an improved express card device with extended USB interface to mitigate and/or obviate the aforementioned problems.

### SUMMARY OF THE INVENTION

An objective of the present invention is to provide an ExpressCard having universal serial bus (USB) connection, which can be conveniently and independently operated as a standard USB product.

Another objective of the present invention is to provide an ExpressCard having universal serial bus (USB) connection, which can overcome the bulky occupancy and the weakened mechanical strength in the prior art.

A further objective of the present invention is to provide an ExpressCard having universal serial bus (USB) connection, which can perform data transmission with a host without polling thereby reducing power consumption.

According to a feature of the invention, an ExpressCard having universal serial bus (USB) connection is provided, which includes a card case having two opposite first and second end portions and two opposite lateral portions; a card connector formed at the first end portion of the card case and having a USB interface; one or more flash chips implemented in the card case; a USB flash controller implemented in the card case and connected between the USB interface and the one or more flash chips in order to provide a data access to the one or more flash chips through the USB interface; and a USB socket implemented in the card case and connected to the USB flash controller in order to provide a data access to the one or more flash chips therethrough.

According to another feature of the invention, an ExpressCard having universal serial bus (USB) connection is provided, which includes a card case having two opposite first and second end portions and two opposite lateral portions; a card connector formed at the first end portion of the card case and having a PCI express serial interface and a USB interface; one or more flash chips implemented in the card case; a PCI express and USB flash controller implemented in the card case and connected between the PCI express serial interface and USB interface and the one or more flash chips in order to provide a data access to the one or more flash chips through the PCI express serial interface or the USB interface; a USB socket implemented in the card case and connected with the PCI express and USB flash controller in order to provide a data access to the one or more flash chips therethrough; and a switch connected to the PCI express and USB flash controller, the USB interface and USB socket in order to switch the PCI express and USB flash controller to the USB interface or the USB socket.

According to a further feature of the invention, an ExpressCard having universal serial bus (USB) connection is provided, which includes a card case having two opposite first and second end portions and two opposite lateral portions; a card connector formed at the first end portion of the card case and having a PCI express serial interface; one or more flash chips implemented in the card case; a PCI express and USB flash controller implemented in the card case and connected to the PCI express serial interface in order to provide a data access to the one or more flash chips through the PCI express serial interface; and a USB socket implemented in the card case and connected to the PCI express and USB flash controller in order to provide a data access to the one or more flash chips therethrough, wherein the PCI express and USB flash controller is based on a pin of the USB socket to determine the USB socket to be enabled or not.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of adding a standard USB connector to a typical ExpressCard through a USB adapter;

FIG. 2(A) is a schematic view of a look of an ExpressCard having USB connection according to the invention;

FIG. 2(B) is a schematic view of another look of an ExpressCard having USB connection according to the invention;

FIG. 3(A) shows a USB socket of extended mini-connector-type;

FIG. 3(B) shows a USB plug of extended mini-connector-type;

FIG. 4 is a functional block diagram of a first embodiment of an ExpressCard having USB connection according to the invention;

FIG. 5 is a functional block diagram of a second embodiment of an ExpressCard having USB connection according to the invention;

FIG. 6 is a functional block diagram of a third embodiment of an ExpressCard having USB connection according to the invention;

FIG. 7 is a functional block diagram of a fourth embodiment of an ExpressCard having USB connection according to the invention;

FIG. 8 is a functional block diagram of a fifth embodiment of an ExpressCard having USB connection according to the invention;

FIG. 9 is a functional block diagram of a sixth embodiment of an ExpressCard having USB connection according to the invention;

FIG. 10 is a functional block diagram of a seventh embodiment of an ExpressCard having USB connection according to the invention;

FIG. 11 is a block diagram of a simplified host and ExpressCard connected with an extended Universal-Serial Bus;

FIG. 12 shows an ExpressCard connected to a EUSB host;

FIG. 13 is a flow diagram highlighting reading of an ExpressCard with EUSB without polling;

FIG. 14 is a flow diagram highlighting writing to an ExpressCard with EUSB without polling;

FIGS. 15A-B are packet-timing diagrams showing sequences of packets being sent to and received from the ExpressCard with EUSB;

FIG. 16 is a flowchart of a basic IN protocol flow with not-acknowledge (NACK) to avoid polling;

FIG. 17 is a flowchart of a basic OUT protocol flow with not-acknowledge (NACK) to avoid polling;

FIGS. 18A-B show a flowchart of an EUSB host suspending while an ExpressCard with EUSB is busy during an IN transfer; and

FIGS. 19A-B show a flowchart of an EUSB host suspending while an ExpressCard with EUSB is busy during an OUT transfer.

### DETAILED DESCRIPTION OF THE PREFERRED EMBODIMENT

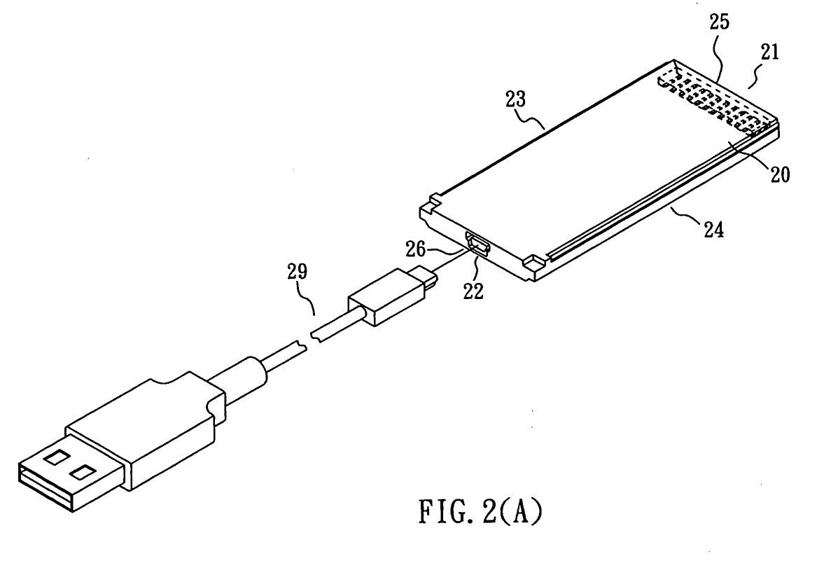

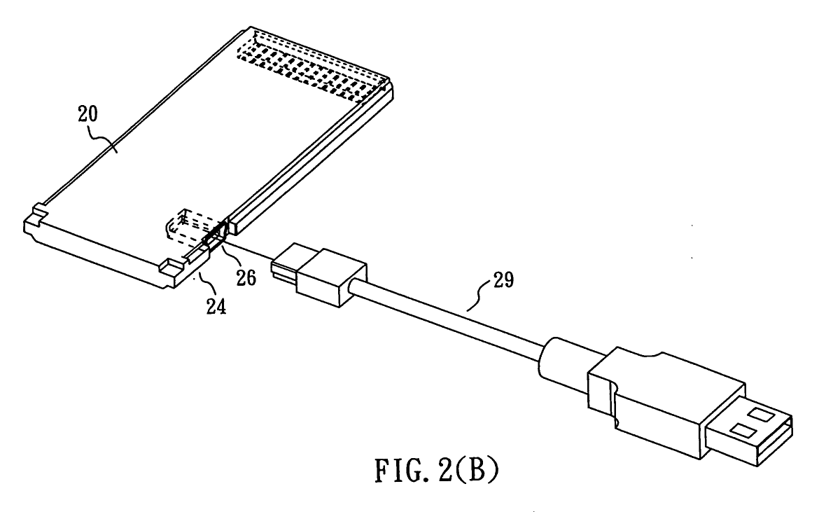

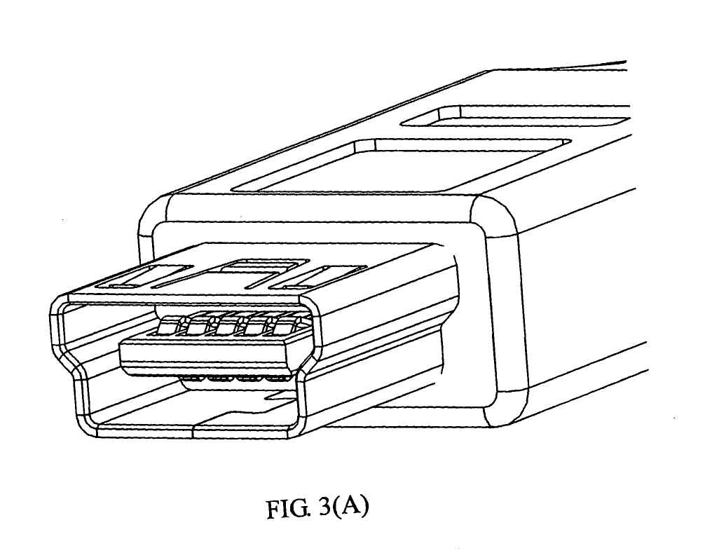

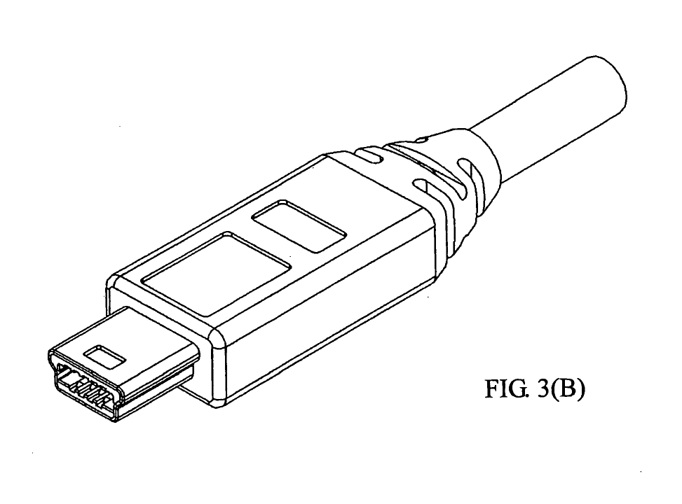

FIG. 2(A) is a schematic view of a look of an ExpressCard having USB connection according to the invention. The ExpressCard includes a card case 20 having two opposite first and second end portions 21, 22 and two opposite lateral portions 23, 24. A card connector 25 is formed at the first end portion 21 of the card case 20 and has a PCI express serial interface and a USB interface. In addition, a USB socket 26 is implemented at the second end portion 22, as shown in FIG. 2, or at one of the lateral portions 23 and 24, as shown in FIG. 2(B), of the card case 20. The USB socket 26 is preferably a mini-connector-type USB socket or an extended mini-connector-type USB socket, which can cooperate with an external USB cable 29 to thereby allow the ExpressCard to function as an independent standard USB product and to connect to a USB socket of a computer or equipment. The USB socket 26 can support a standard USB transmission interface such as the mini-connector-type USB, or an extended mini USB transmission interface such as the extended mini-connector-type USB. The extended mini USB transmission interface is illustrated in FIGS. 3(A) and 3(B) for reference, wherein FIG. 3(A) shows a USB socket of extended mini-connector-type and FIG. 3(B) shows a USB plug of extended mini-connector-type.

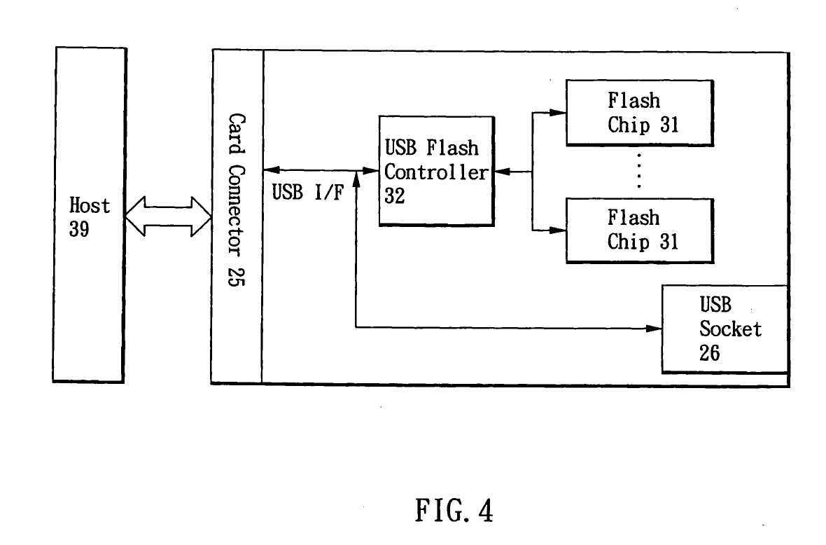

FIG. 4 is a functional block diagram of a first embodiment of an ExpressCard having USB connection. In this embodiment, the ExpressCard includes a card connector 25 formed at the end portion 21 of the card case 20, one or more flash chips 31 implemented in the card case 20, a USB flash controller 32 implemented in the card case 20 and a USB socket 26 implemented in the card case 20. The card connector 25 has the USB interface in order to connect to a host 39 for providing the data communication between the host 39 and the ExpressCard. The USB flash controller 32 is connected between the USB interface of the card connector 25 and the one or more flash chips 31 in order to allow the host 39 to access data to the one or more flash chips through the USB interface of the card connector 25. The USB socket 26 is connected to the USB flash controller 32 in order to provide a data access to the one or more flash chips 31 therethrough. Accordingly, in addition to connecting with the host 39 through the card connector 25, the ExpressCard can connect with a computer or equipment equipped with a standard USB socket through the USB socket 26 and the external USB cable 29.

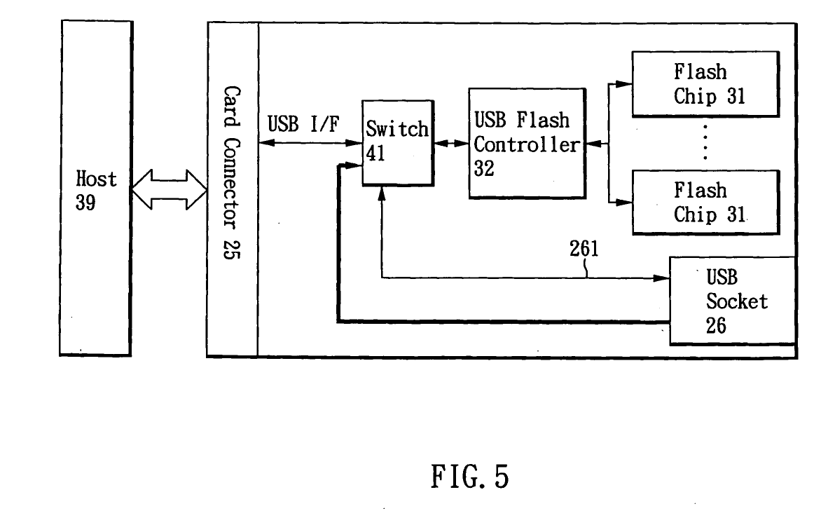

FIG. 5 is a functional block diagram of a second embodiment of an ExpressCard having USB connection. In this embodiment, the ExpressCard includes a card connector 25 formed at the end portion 21 of the card case 20, one or more flash chips 31 implemented in the card case 20, a USB flash controller 32 implemented in the card case 20, a switch 41 implemented in the card case 20 and a USB socket 26 implemented in the card case 20. The card connector 25 has the USB interface in order to connect to a host 39 for providing the data communication between the host 39 and the ExpressCard. The switch 41 is connected with the USB interface of the card connector 25, the USB socket 26 and the USB flash controller 32 in order to switch the USB flash controller 32 to the USB interface of the card connector 25 or the USB socket 26. The USB flash controller 32 is connected with the USB interface of the card connector 25 through the switch 41 and connects the one or more flash chips 31 in order to allow the host 39 to access data to the one or more flash chips through the USB interface of the card connector 25. The USB socket 26 is connected with the USB flash controller 32 through the switch 41 in order to provide a data access to the one or more flash chips 31 therethrough. It is determined by a detection pin 261 of the USB socket 26 that the switch 41 switches the USB flash controller 32 to the USB interface of the card connector 25 or the USB socket 26. For example, when USB socket 26 is connected to the external USB cable 29, the detection pin 261 drives the switch 41 to switch the USB flash controller 32 to the USB socket 26, and otherwise to the USB interface of the card connector 25. Accordingly, in addition to connecting with the host 39 through the card connector 25, the ExpressCard can connect with a computer or equipment equipped with a standard USB socket through the USB socket 26 and the external USB cable 29. In addition, the circuitry damage caused by concurrently using the card connector 25 and the USB socket 26 is avoided.

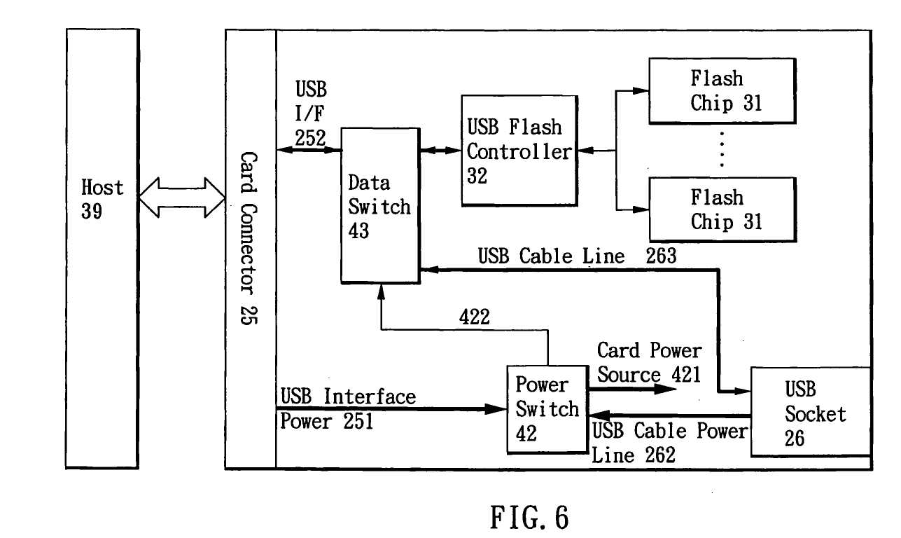

FIG. 6 is a functional block diagram of a third embodiment of an ExpressCard having USB connection. In this embodiment, the ExpressCard includes a card connector 25 formed at the end portion 21 of the card case 20, one or more flash chips 31 implemented in the card case 20, a USB flash controller 32 implemented in the card case 20, a power switch 42 implemented in the card case 20, a data switch 43 implemented in the card case 20, and a USB socket 26 implemented in the card case 20. The card connector 25 has the USB interface power source 251 and the USB interface 252 in order to connect to a host 39 for providing the data communication between the host 39 and the ExpressCard and further powering the ExpressCard.

The power switch 42 is connected with the USB interface power source 251 of the card connector 25 and a USB cable power line 262 of the USB socket 26 in order to switch the USB flash controller 32 and the flash chips 31 to the USB interface power source 251 or the USB cable power line 262.

The USB flash controller 32 is connected with the USB interface 252 of the card connector 25 through the data switch 43 and to the flash chips in order to allow the host 39 to access the data of the flash chips 31 through the USB interface 252 of the card connector 25. The USB socket 26 is connected with the USB flash controller 32 through the data switch 43 in order to provide a data access to the flash chips 31 through the USB cable data line 263. The power switch 42 produces an interface/cable data switching signal 422 to accordingly determine that the data switch 43 switches the USB flash controller 32 to the USB interface 252 or the USB cable data line 263 for a data access. For example, when the USB socket 26 is connected to the external USB cable 29, the power switch 42 connects the USB cable power line 262 to the card power source 421, and accordingly the card power source 421 (namely the USB cable power line 262) can power the USB flash controller 32 and the flash chips 31 in operation. In this case, the interface/cable data switching signal 422 drives the data switch 43 to connect the USB flash controller 32 to the USB cable data line 263 of the USB socket 26. Conversely, when the card connector 25 is connected to the host 39, the power switch 42 connects the USB interface power source 251 to the card power source 421, and accordingly the card power source 421 (namely the USB interface power source 251) can supply power to the USB flash controller 32 and the flash chips 31 in operation. In this case, the interface/cable data switching signal 422 drives the data switch 43 to disconnect the USB cable data line 263 of the USB socket 26 and to connect the USB flash controller 32 to the USB interface 252 of the card connector 25. Therefore, the ExpressCard having USB connection can be connected to the host 39 through the card connector 25 and to a computer or equipment with a standard USB socket through the USB socket 26 and the external USB cable 29. The circuitry damage caused by concurrently using the card connector 25 and the USB socket 26 is avoided.

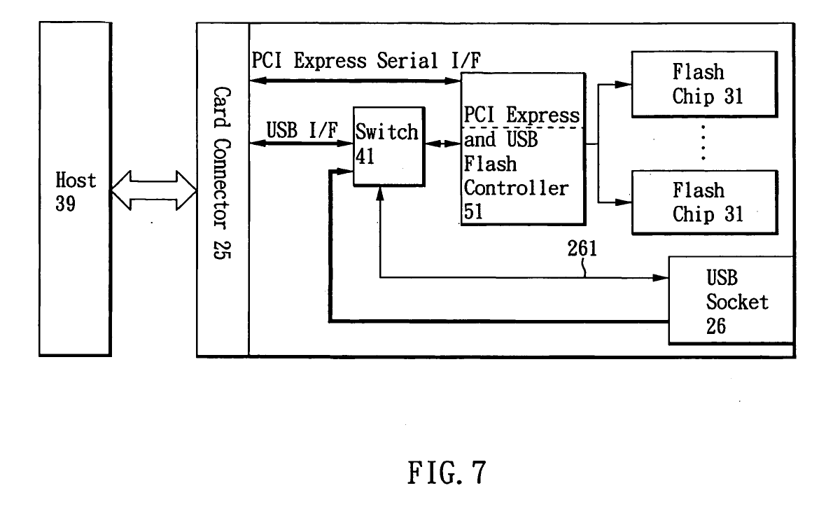

FIG. 7 is a functional block diagram of a fourth embodiment of an ExpressCard having USB connection. In this embodiment, the ExpressCard includes a card connector 25 formed at the first end portion 21 of the card case 20, one or more flash chips 31 implemented in the card case 20, a PCI express and USB flash controller 51 implemented in the card case 20, a switch 41 implemented in the card case 20 and a USB socket 26 implemented in the card case 20. The PCI express and USB flash controller 51 can be a chip pair, one for the PCI express controller and the other for the USB flash controller, not limited to a single chip. The card connector 25 has a PCI express serial interface and a USB interface in order to connect the ExpressCard to the host 39 for providing the data communication between the ExpressCard and the host 39. The switch 41 is connected between the PCI express and USB flash controller 51 and the USB interface and USB socket 26 in order to switch the PCI express and USB flash controller 51 to the USB interface of the card connector 25 or the USB socket 26. The PCI express and USB flash controller 51 is connected between the PCI express serial interface and the one or more flash chips and also connected with the USB interface of the card connector through the switch 41 in order to provide the host 39 to access data of the one or more flash chips 31 through the PCI express serial interface and USB interface of the card connector 25. The USB socket 26 is connected with the PCI express and USB flash controller 51 through the switch 41 in order to provide a data access to the one or more flash chips 31 therethrough. A detection pin 261 of the USB socket 26 can determine that the switch 41 switches the PCI express and USB flash controller 51 to the USB interface of the card connector 25 or the USB socket 26. For example, when the USB socket 26 is connected with the external USB cable 29, the detection pin 261 drives the switch 41 to connect the PCI express and USB flash controller 51 to the USB socket 26, and otherwise to the USB interface of the card connector 25. Therefore, the ExpressCard having USB connection can be connected to the host 39 through the card connector 25 and to a computer or equipment with a standard USB socket through the USB socket 26 and the external USB cable 29. The circuitry damage caused by concurrently using the card connector 25 and the USB socket 26 is avoided.

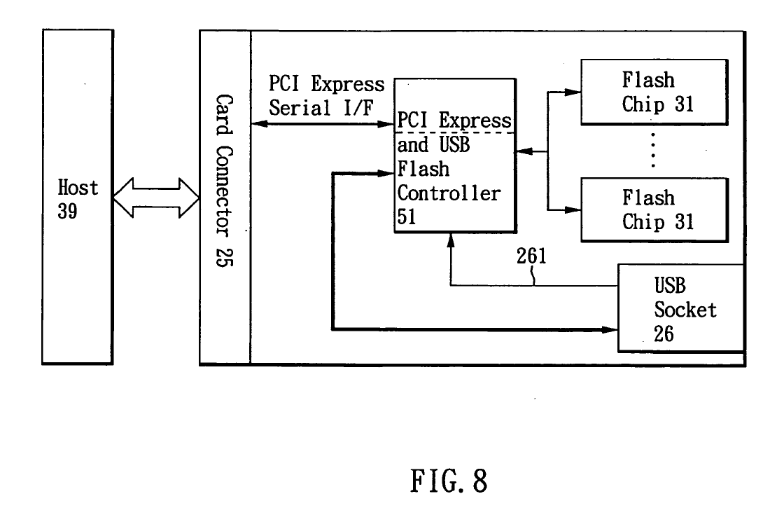

FIG. 8 is a functional block diagram of a fifth embodiment of an ExpressCard having USB connection. In this embodiment, the ExpressCard includes a card connector 25 formed at the end portion 21 of the card case 20, one or more flash chips 31 implemented in the card case 20, a PCI express and USB flash controller 51 implemented in the card case 20 and a USB socket 26 implemented in the card case 20. The PCI express and USB flash controller 51 can be a chip pair, one for the PCI express controller and the other for the USB flash controller, not limited to a single chip. The card connector 25 has the PCI express serial interface in order to connect the ExpressCard to the host 39 for providing the data communication between the host 39 and the ExpressCard. The PCI express and USB flash controller 51 is connected between the PCI express serial interface of the card connector 25 and the one or more flash chips 31 in order to allow the host 39 to access data to the one or more flash chips 31 through the PCI express serial interface of the card connector 25. The USB socket 26 is connected to the PCI express and USB flash controller 51 in order to provide a data access to the one or more flash chips 31 therethrough. The PCI express and USB flash controller 51 is based on a detection pin 261 of the USB socket 26 to determine the USB socket 26 to be enabled or not. For example, when the USB socket 26 is connected to an external USB cable, the detection pin 261 drives the PCI express and USB flash controller 51 to enable the USB socket 26.

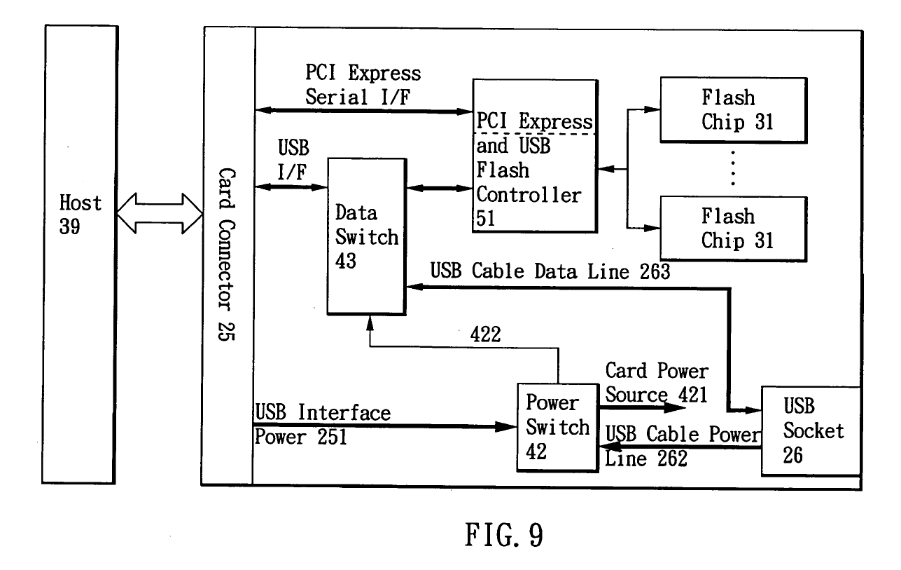

FIG. 9 is a functional block diagram of a sixth embodiment of an ExpressCard having USB connection, which is as same as that of FIG. 6 except that a PCI express and USB flash controller 51 in FIG. 9 replaces the USB flash controller 32 in FIG. 6. The PCI express and USB flash controller 51 can be a chip pair, one for the PCI express controller and the other for the USB flash controller, not limited to a single chip. In this case, the card connector 25 has a PCI express serial interface and a USB interface in order to connect the ExpressCard to a host 39 for providing the data communication between the ExpressCard and the host 39. The remainders have as same functions as those of FIG. 6, so a detailed description is deemed unnecessary.

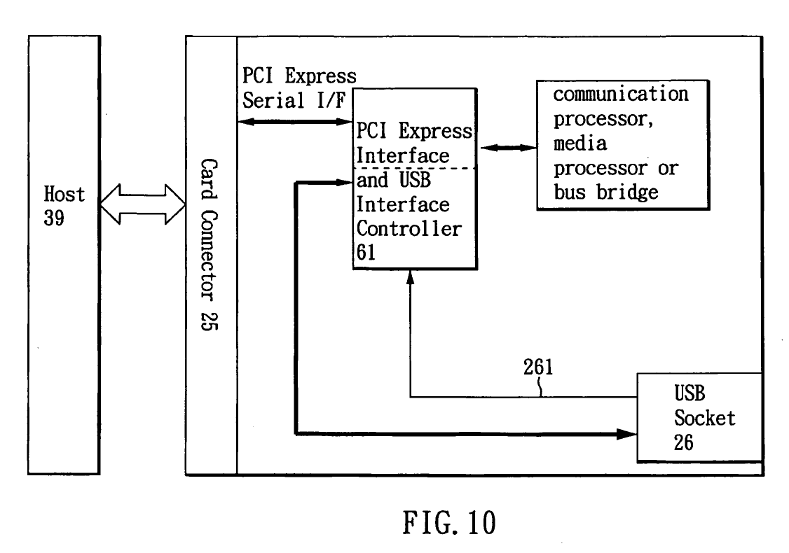

FIG. 10 is a functional block diagram of a seventh embodiment of an ExpressCard having USB connection. In this embodiment, the ExpressCard includes a card connector 25 formed at the end portion 21 of the card case 20, a functional device 62 implemented in the card case 20, a PCI express interface and USB interface controller 61 implemented in the card case 20 and a USB socket 26 implemented in the card case 20. The functional device 62 can be a communication processor, a media processor or a bus bridge. The PCI express interface and USB interface controller 61 can be a chip pair, one for the PCI express interface controller and the other for the USB interface controller, not limited to a single chip. The card connector 25 has the PCI express serial interface in order to connect the ExpressCard to the host 39 for providing the data communication between the host 39 and the ExpressCard. The PCI express interface and USB interface controller 61 is connected between the PCI express serial interface of the card connector 25 and the communication or media processor or bus bridge 62 in order to allow the host 39 to access data to the communication or media processor or bus bridge 62 through the PCI express serial interface of the card connector 25. The USB socket 26 is connected to the PCI express interface and USB interface controller 61 in order to provide a data access to the communication or media processor or bus bridge 62 therethrough. The PCI express interface and USB interface controller 61 is based on a detection pin 261 of the USB socket 26 to determine the USB socket 26 to be enabled or not. For example, when the USB socket 26 is connected to an external USB cable, the detection pin 261 drives the PCI express and USB flash controller 51 to enable the USB socket 26.

As cited, the invention adds a mini-connector-type or extended mini-connector-type USB socket at the end or lateral of the ExpressCard to thereby allow the ExpressCard to be function as an independent standard USB product when the USB socket connects to an external USB cable. Thus, the externally bulky dedicated adapter is not required, and the volume limit or the weaken mechanical strength in use are avoided. In addition, the USB cable can be the standard commercial goods, which provides a convenience in use.

When the USB socket 26 in the above embodiments is an extended mini-connector-type USB socket, the data transmission between the ExpressCard and the host 39 is carried out with a low power extended USB protocol without polling, which is described hereinafter.

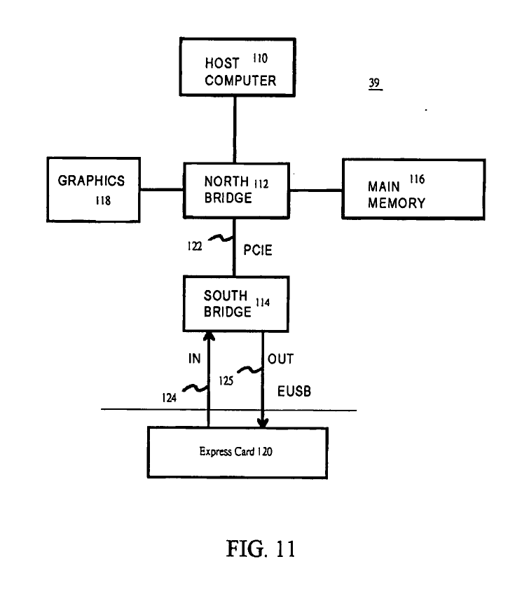

FIG. 11 is a block diagram of a simplified host 39 and ExpressCard 120 connected with an extended Universal-Serial Bus (EUSB). Host computer 110 executes instructions including those in user and application programs, operating systems, device drivers, and other applets. Main memory 116 may be a dynamic random-access memory (DRAM) or other kind of RAM that stores instructions and data that is accessed by the central processing unit (CPU) in host computer 110.

North bridge 112 contains bus and memory controllers that generate control signals of the proper timing to main memory 116 and to graphics system 118. North bridge 112 also contains a Peripheral Components Interconnect Express (PCIE) controller that generates transactions on PCIE bus 122.

PCIE bus 122 connects north bridge 112 to south bridge 114. South bridge 114 also contains bus controllers and bus logic. An extended Universal-Serial Bus (EUSB) controller in south bridge 114 converts PCIE transactions into EUSB transactions that are sent to Expresscard 120 over the EUSB bus. However, rather than time-duplex a single differential pair of lines, two differential pairs are provided, allowing full-duplex data transfers. OUT differential pair 125 can be sending data from the host 39 to ExpressCard 120 at the same time that IN differential pair 124 is sending data read from Expresscard 120 back to host computer 110. Thus Expresscard 120 provides a higher performance than an ordinary USB 2.0 device that is only half-duplex.

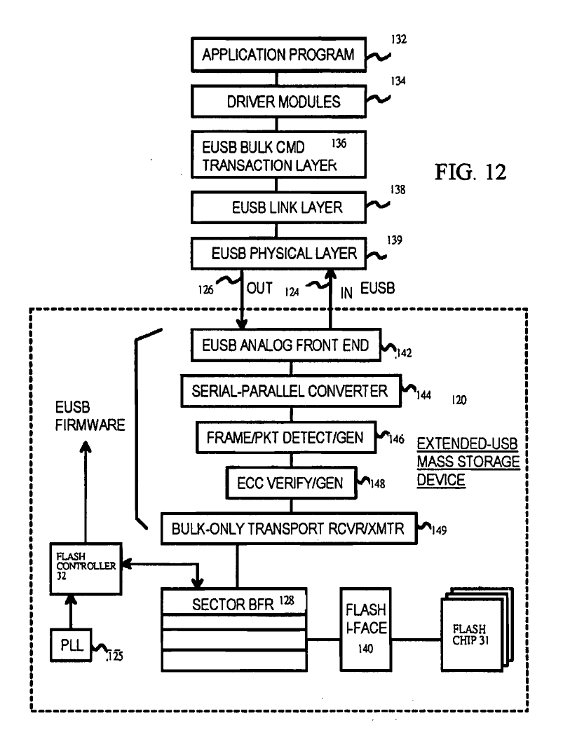

FIG. 12 shows an ExpressCard, as those shown in FIGS. 4-9, connected to a EUSB host 39. Application program 132 on the host 39 needs to read data that is stored in flash chip 31 on ExpressCard 120. Application program 132 sends a data-read request to a device driver for the flash in device modules 134, which activate EUSB bulk-only-transfer and command transaction layer 136. EUSB bulk-only-transport and command transaction layer 136 embed a read command inside a EUSB data payload and header using the bulk-only-transport mode of USB. A cyclical-redundancy-check (CRC) checksum is also attached.

EUSB link layer 138 adds a sequence number and another CRC checksum, while EUSB physical layer 139 adds packet framing and performs 8/10-bit encoding. The framed data packet is sent from the host 39 to ExpressCard 120 over OUT differential pair 125.

EUSB analog front end 142 senses the data transitions on OUT differential pair 125, extracts the clock, and sends serial data to serial-parallel converter 144, which generates parallel data words. The parallel data words are examined by frame and packet detector 146 to locate frame and packet boundaries. The header and data payload can be located by bulk-only-transport receiver 149. ECC generator/checker 148 checks CRC's for error detection. The data payloads can be written into sector buffer 128.

USB flash controller 32 examines the headers and data payloads from bulk-only-transport receiver 149 and detects the read command. USB flash controller 26 activates flash interface 140 to perform a read of flash chip 31, and the flash data read is transferred into sector buffer 128. This flash data in sector buffer 128 is formed into data payloads, a header attached by bulk-only-transport receiver 149, and passed back down the layers for transmission to the host over IN differential pair 124.

Phase-locked loop (PLL) 125 may be driven by an external crystal (not shown) and generates an internal clock to USB flash controller 32 and other components such as sector buffer 128. USB flash controller 32 controls operation of EUSB firmware that may include bulk-only-transport receiver 149, ECC generator/checker 148, frame and packet detector 146, serial-parallel converter 144, and EUSB analog front end 142.

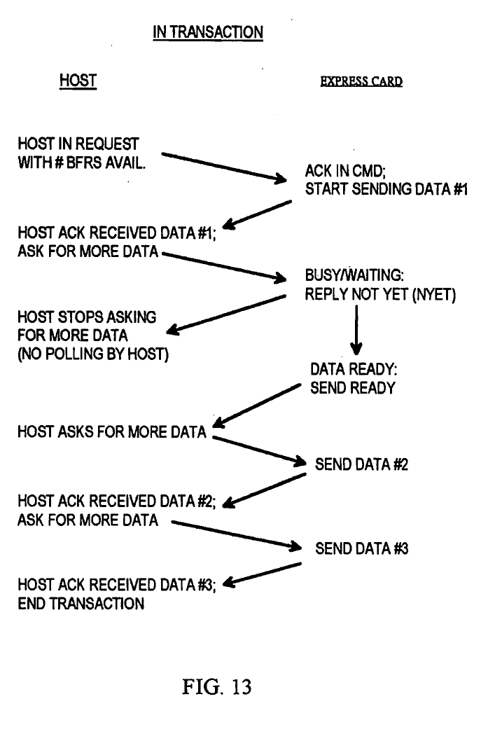

FIG. 13 is a flow diagram highlighting reading of an ExpressCard with EUSB without polling. When the ExpressCard with EUSB is not yet ready to send data to the host, the ExpressCard with EUSB asserts a not yet (NYET) signal to the host. When the ExpressCard with EUSB is ready again to send data, it asserts a ready (RDY) signal to the host, and de-asserts the NYET signal.

The addition of the NYET and RDY signals allows the host to simply monitor these signals to detect when the ExpressCard with EUSB is ready to continue sending data. With the NYET signal, the host no longer has to continuously poll the ExpressCard with EUSB to determine when the data is ready for transmission.

The host is still the bus master and initiates a transfer by sending a packet with the IN request to the ExpressCard with EUSB. The request also contains a number that indicates a number of buffers available in the host, or the number of packets that can be accepted by the host. Other information such as a device identifier or address of the ExpressCard with EUSB can be included in the IN request packet.

The ExpressCard with EUSB receives the IN request packet and sends an acknowledgement ACK back to the host to acknowledge the IN command. The ExpressCard with EUSB also starts reading the requested data and sending the first part of that data when available. This is data packet #1.

The host acknowledges receipt of data packet #1 by sending an ACK packet back to the ExpressCard with EUSB. This ACK packet implicitly also request that the next data packet be sent. However, the ExpressCard with EUSB is not yet ready to send the second data packet, data #2. Perhaps the reading of the flash memory is delayed, or data #2 is not cached while data #1 was cached by the flash controller. The busy ExpressCard with EUSB sends a NYET packet back to the host to indicate that the data is not yet ready.

In response to the NYET packet, the host stops asking for more data. The host does not poll the ExpressCard with EUSB. Instead, the host simply waits. The host may even enter a lower-power state such as a suspend or sleep state.

The ExpressCard with EUSB eventually reads the data, and stores the data in its sector buffer or in another memory buffer. A ready RDY signal is generated to the host, while the NYET signal is de-asserted. The NYET, RDY, and ACK signals may be flags in a packet header that are set or cleared. Thus separate signal lines to the host are not required, and the NYET, RDY, and ACK signals may be carried over the differential pair signal lines with the header, data payloads, framing, and other information in the data stream.

The host responds to the RDY signal by asking for more data to be sent. The ExpressCard with EUSB then forms the data into a packet as data #2, which is sent to the host. The host acknowledges receipt of data #2, and asks for more data. The ExpressCard with EUSB then sends data #3, which the host acknowledges. When the initial IN request had a number of buffers equal to 3, then all requested data is received by the host, and the IN transaction ends.

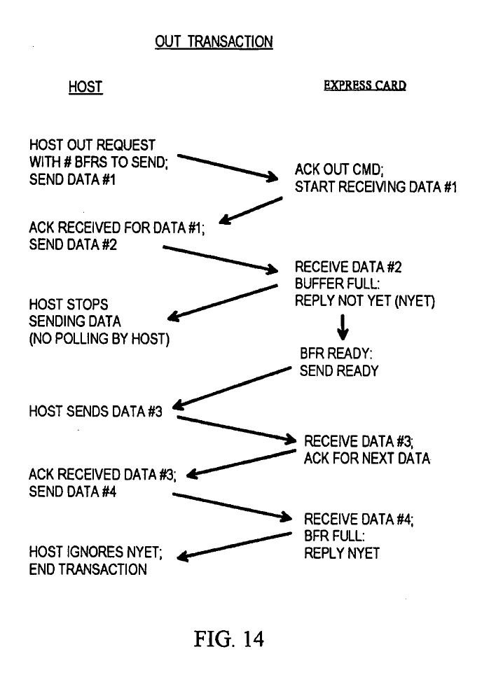

FIG. 14 is a flow diagram highlighting writing to an ExpressCard with EUSB without polling. When writing to the ExpressCard with EUSB, data is buffered in a sector buffer, such as sector buffer 128 (as shown in FIG. 12). The physical writing to the flash memory may be quite slow. Thus sector buffer 128 may fill up before the data can be written to flash memory and deleted from sector buffer 128. When sector buffer 128 is full, the host must stop sending more data, since there is no place to store this additional data. A buffer overflow may otherwise occur.

When sector buffer 128 is full, the ExpressCard with EUSB is not yet ready to receive more data from the host. The ExpressCard with EUSB asserts a not yet (NYET) signal to the host. When the ExpressCard with EUSB is ready again to receive data, it asserts a ready (RDY) signal to the host, and de-asserts the NYET signal.

The addition of the NYET and RDY signals allows the host to simply monitor these signals to detect when the ExpressCard with EUSB is ready to continue receiving data. With the NYET signal, the host no longer has to continuously poll the ExpressCard with EUSB to determine when the data may be transmitted.

The host is still the bus master and initiates a transfer by sending a packet with the OUT request to the ExpressCard with EUSB. The request also contains a number that indicates a number of buffers or packets of data from the host. Other information such as a device identifier or address of the ExpressCard with EUSB can be included in the OUT request packet.

The ExpressCard with EUSB receives the OUT request packet and sends an acknowledgement ACK back to the host to acknowledge the OUT command. The ExpressCard with EUSB also starts receiving and buffering the requested data. This is data packet #1.

The ExpressCard with EUSB acknowledges receipt of data packet #1 by sending an ACK packet back to the host. This ACK packet implicitly also request that the next data packet be sent. The host responds by sending data packet #2.

However, the buffer on the ExpressCard with EUSB fills up after receiving data packet #2. The ExpressCard with EUSB is busy writing the buffered data to the flash memory and must wait until this writing is complete and space is made available in the second buffer. The busy ExpressCard with EUSB sends a NYET packet back to the host to indicate that the ExpressCard with EUSB is not yet ready to receive more data.

In response to the NYET packet, the host stops sending more data. The host does not poll the ExpressCard with EUSB. Instead, the host simply waits. The host may even enter a lower-power state such as a suspend or sleep state.

The ExpressCard with EUSB eventually writes the data, and more space is made available in its sector buffer or in another memory buffer. A ready RDY signal is generated to the host, while the NYET signal is de-asserted.

The host responds to the RDY signal by sending more data to the ExpressCard with EUSB. The ExpressCard with EUSB receives the data as data #3. The ExpressCard with EUSB acknowledges receipt of data #3, and asks for more data. The host then sends data #4, which the ExpressCard with EUSB acknowledges. However, the ExpressCard with EUSB can only buffer 2 data packets, so the sector buffer is again full. The busy ExpressCard with EUSB again sends a NYET packet back to the host to indicate that the ExpressCard with EUSB is not yet ready to receive more data.

When the initial OUT request had a number of buffers equal to 4, then all requested data has been received by the ExpressCard with EUSB. The host ignores the NYET signal, since all data has been transmitted. The host then ends the OUT transaction.

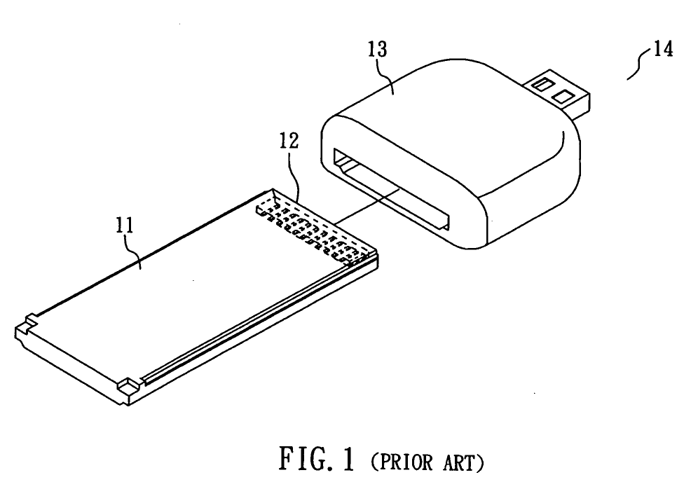

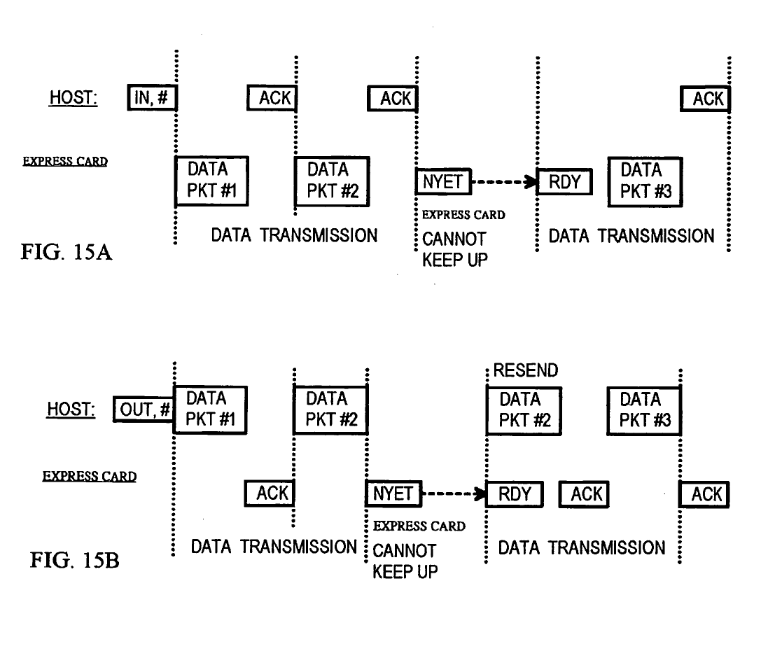

FIGS. 15A-B are packet-timing diagrams showing sequences of packets being sent to and received from the ExpressCard with EUSB. In FIG. 1 SA, the host sends a request to read flash memory from an ExpressCard with EUSB. The read request is embedded inside an IN packet that also contains a number of packets of data to read.

The ExpressCard with EUSB receives the IN packet and begins reading the data. The data may already be buffered in a cache or other buffer, such as when read-ahead caching occurs from an earlier read access. The ExpressCard with EUSB forms the first part of the requested data into data packet #1, which is sent back to the host.

The host sends an acknowledgement ACK to acknowledge receipt of data packet #1, and to request that the next packet be sent. The ExpressCard with EUSB reads the next data, forming data packet #2, which is also sent to the host.

The host sends another acknowledgement ACK to acknowledge receipt of data packet #2, and to request that the next packet be sent. However, the ExpressCard with EUSB cannot keep up with the pace of the host. The ExpressCard with EUSB sends a not yet NYET packet to the host since the next data is not yet ready.

The host responds to NYET signal by waiting. The host does not poll the ExpressCard with EUSB, but simply waits. After some time, the ExpressCard with EUSB catches up, and sends a ready RDY signal to the host. The ExpressCard with EUSB reads the next data, forming data packet #3, which is also sent to the host. The host sends an acknowledgement ACK to acknowledge receipt of data packet #3. Since only 3 packets were requested with the IN packet, the IN transaction ends.

In FIG. 15B, the host sends a request to write to flash memory in an ExpressCard with EUSB. The write request is embedded inside an OUT packet that also contains a number of packets of data to write. The host forms the first part of the write data into data packet #1, which is sent to the ExpressCard with EUSB after the OUT packet is sent.

The ExpressCard with EUSB receives the OUT packet and begins writing the data from data packet #1. The data may first be buffered in a cache or other buffer before writing to flash memory.

The ExpressCard with EUSB sends an acknowledgement ACK to acknowledge receipt of data packet #1, and to request that the next packet be sent. The host forms the next data into data packet #2, which is also sent to the ExpressCard with EUSB.

The ExpressCard with EUSB buffer is now full. The ExpressCard with EUSB cannot keep up with the pace of the host. The ExpressCard with EUSB sends a not yet NYET packet to the host since the sector buffer is full, and the ExpressCard with EUSB cannot receive more data.

The host responds to NYET signal by waiting. The host does not poll the ExpressCard with EUSB, but simply waits. After some time, the ExpressCard with EUSB catches up, and sends a ready RDY signal to the host. Since the ExpressCard with EUSB did not acknowledge receipt of data packet #2, the host re-sends data packet #2. The ExpressCard with EUSB buffers this data, and sends an acknowledgement ACK for the re-sent data packet #2.

The host forms data packet #3, which is also sent to the ExpressCard with EUSB. The ExpressCard with EUSB sends an acknowledgement ACK to acknowledge receipt of data packet #3. Since only 3 packets were requested with the OUT packet, the OUT transaction ends.

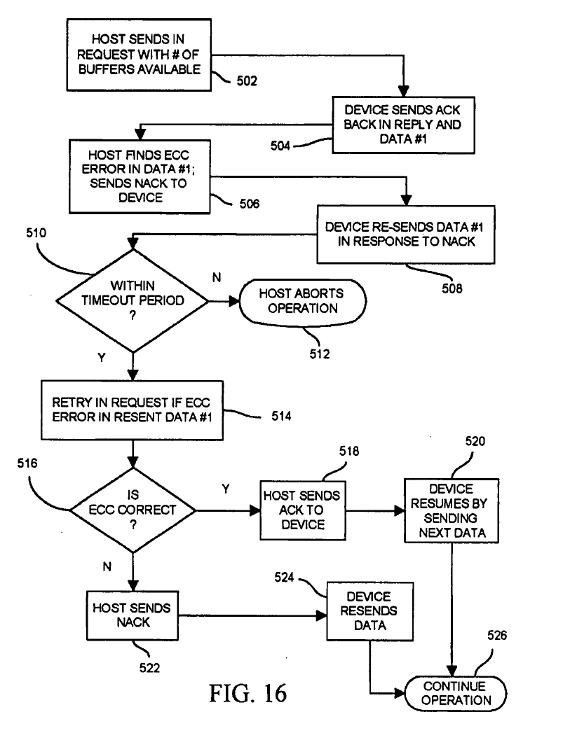

FIG. 16 is a flowchart of a basic IN protocol flow with not-acknowledge (NACK) to avoid polling. The EUSB host sends an IN request with the number of packet-buffers to transfer, step 502. The ExpressCard with EUSB sends back an acknowledgement ACK to the IN request and sends the first packet of data, step 504.

The host checks the transmitted data for errors by generating a CRC of the received data and comparing the generated CRC to a stored or transmitted CRC that was computed on the pre-transmitted data. When the CRC's mismatch, an error is detected. When the host finds an error using ECC, step 506, the host sends back a not-acknowledge (NACK) rather than an acknowledgement ACK.

The ExpressCard with EUSB responds to the NACK by re-sending the previous data, step 508. If the host does not receive the re-sent data within the timeout period, step 510, then the operation is aborted, step 512.

When the response is received within the timeout period, step 510, then the CRC or Error-Correction-Code (ECC) is checked on the re-sent data, step 516. When ECC is used rather than CRC, small errors may be corrected without requiring re-sending of the data. When the ECC indicates that the re-sent data is correct, step 516, then the host sends an acknowledgement ACK to the ExpressCard with EUSB, step 518. The ExpressCard with EUSB resumes by sending the next data packet, step 520, and the operation continues, step 526.

When the ECC indicates that the re-sent data has an error, step 516, then the host sends a not-acknowledgement NACK to the ExpressCard with EUSB, step 522. The ExpressCard with EUSB responds by re-sending the data, step 524, and the operation continues, step 510.

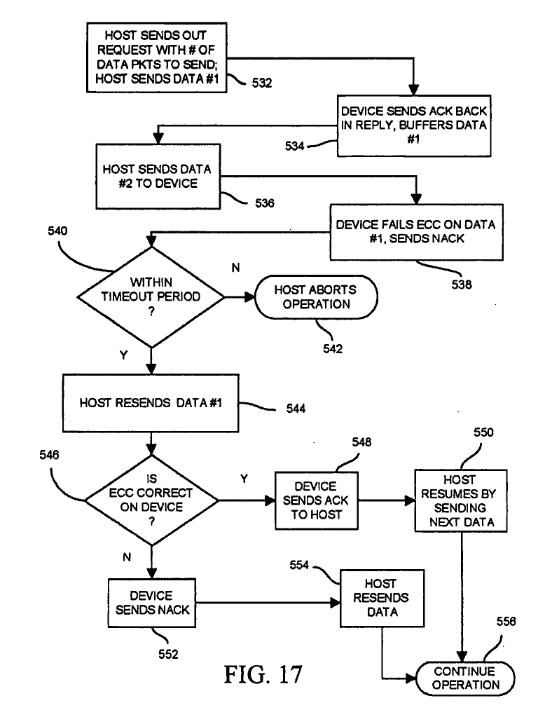

FIG. 17 is a flowchart of a basic OUT protocol flow with not-acknowledge (NACK) to avoid polling. The EUSB host sends an OUT request with the number of packet-buffers to transfer, step 532. The host also sends the first data for writing into the ExpressCard with EUSB, step 532.

The ExpressCard with EUSB buffers the first data packet and sends back an acknowledgement ACK to the OUT request, step 534. The host receives the ACK and sends the second data packet, data #2, step 536.

The ExpressCard with EUSB checks the transmitted data for errors by generating a CRC of the received data and comparing the generated CRC to a stored or transmitted CRC that was computed on the pre-transmitted data. When the CRC's mismatch, an error is detected. When the ExpressCard with EUSB finds an error using ECC, step 538, the ExpressCard with EUSB sends back a not-acknowledge (NACK) rather than an acknowledgement ACK.

If the host does not receive the response from the ExpressCard with EUSB within the timeout period, step 540, then the operation is aborted, step 542. Otherwise, when the host responds to the NACK by re-sending the previous data, step 544.

When the response is received within the timeout period, step 540, then the CRC or Error-Correction-Code (ECC) is checked by the ExpressCard with EUSB on the re-sent data, step 546. When the ECC indicates that the re-sent data is correct, step 546, then the ExpressCard with EUSB sends an acknowledgement ACK to the host, step 548. The host resumes by sending the next data packet, step 550, and the operation continues, step 556.

When the ECC indicates that the re-sent data has an error, step 546, then the ExpressCard with EUSB sends a not-acknowledgement NACK to the host, step 552. The host responds by re-sending the data, step 554, and the operation continues, step 540.

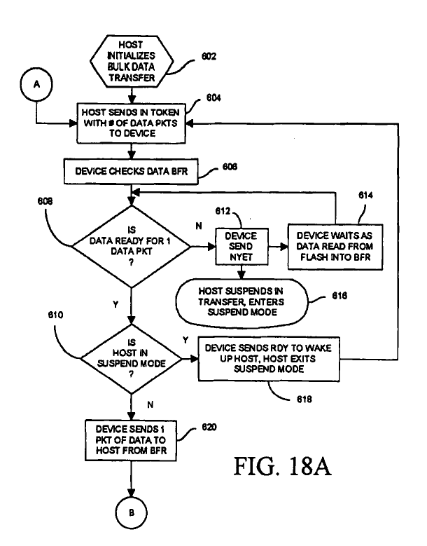

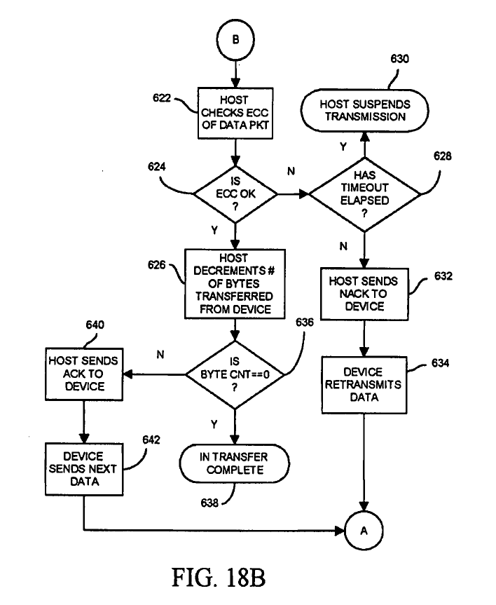

FIGS. 18A-B show a flowchart of an EUSB host suspending while an ExpressCard with EUSB is busy during an IN transfer. In FIG. 18A, an EUSB host initiates a transfer using the bulk-only-transfer mode, step 602. The host sends an IN token in a packet to the ExpressCard with EUSB, step 604, with the number of data packets as a parameter in the IN packet.

The ExpressCard with EUSB receives the IN packet and checks its sector buffer or other cache, step 606, to determine if the first packet of the requested data has already been read. The first packet could have been read earlier and cached in the sector buffer.

When the ExpressCard with EUSB has at least 1 packet ready, step 608, and the host is not in the sleep mode, step 610, then the ExpressCard with EUSB sends one packet of data from its sector buffer to the host, step 620. The flow then continues with FIG. 18B.

For many read operations, the data is not cached by the ExpressCard with EUSB. Step 608 fails because the requested data has not yet been read from the flash memory and loaded into the sector buffer. The ExpressCard with EUSB sends a not yet NYET signal to the host, step 612, and the host suspends the current IN transfer and enters a sleep mode to save power, step 616.

While the host is in the sleep mode, step 616, the ExpressCard with EUSB reads the requested data from its flash memory. The flash data is written into the sector buffer, step 614. When a full packet of flash data has been read from flash into the sector buffer, step 608, and the host is not in the sleep mode, step 610, then the ExpressCard with EUSB sends one packet of data from its sector buffer to the host, step 620. The flow then continues with FIG. 18B.

However, when the host is still in the sleep mode, step 610, then the ExpressCard with EUSB sends a ready RDY signal to the host, step 618. The ready signal causes the host to wake up from its sleep mode. Since the host has already suspended the current IN transfer, step 616, the host can re-start the current IN transfer from step 604 with another IN packet. However, this time the requested data should be in the sector buffer, and steps 608, 610 will pass, allowing the buffered data to be immediately transferred from the sector buffer to the host, step 620.

In FIG. 18B, after the first packet has been sent to the host in step 620, the host checks the data packet for errors, such as by generating a CRC, step 622. ECC code may also be used with error correction of small errors such as 1-bit errors. When the CRC or ECC is good, step 624, then the host decrements the bytes transfer count by the number of bytes received, step 626. When the byte count reaches zero, step 636, the transfer is completed, step 638. Otherwise, the host sends an acknowledgement ACK to the ExpressCard with EUSB, step 640, and the ExpressCard with EUSB sends the next data packet, using the flow from step 606 of FIG. 18A.

When the CRC or ECC is bad, step 624, and the timeout has elapsed, step 628, then the host suspends the current IN transfer, step 630. When timeout has not yet elapsed, step 628, the host sends a not-acknowledge NACK to the ExpressCard with EUSB, step 632, since the received data had an error. The ExpressCard with EUSB re-sends the current data packet, step 634, and the flow continues from step 606 of FIG. 18A.

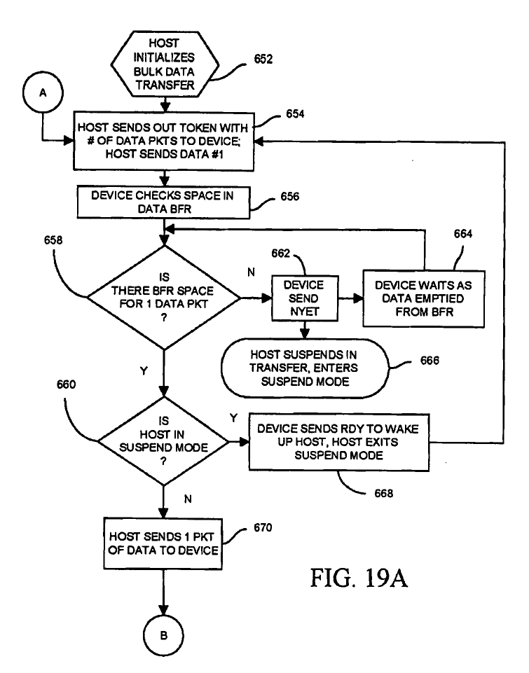

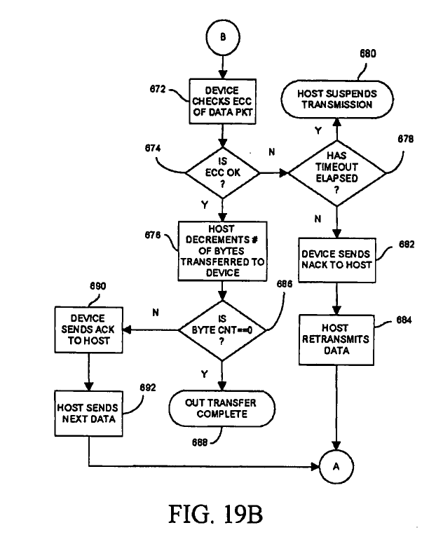

FIGS. 19A-B show a flowchart of an EUSB host suspending while an ExpressCard with EUSB is busy during an OUT transfer. In FIG. 19A, an EUSB host initiates a transfer using the bulk-only-transfer mode, step 652. The host sends an OUT token in a packet to the ExpressCard with EUSB, step 654, with the number of data packets as a parameter in the OUT packet.

The ExpressCard with EUSB receives the OUT packet and checks for empty space in its sector buffer or other cache, step 656, to determine if there is enough room to store the first packet.

When the ExpressCard with EUSB can accept at least 1 packet, step 658, and the host is not in the sleep mode, step 660, then the ExpressCard with EUSB receives one packet of data sent by the host, step 670. The packet is written into the sector buffer of the ExpressCard with EUSB. The flow then continues with FIG. 19B.

Write operations to flash tend to be relatively slow, so the sector buffer may already be full. Step 658 fails because the sector buffer is full of old data that has not yet been written into the flash memory and removed from the sector buffer. The ExpressCard with EUSB sends a not yet NYET signal to the host, step 662, and the host suspends the current OUT transfer and enters a sleep mode to save power, step 666.

While the host is in the sleep mode, step 666, the ExpressCard with EUSB writes data from its sector buffer into its flash memory. Eventually, enough data is written to flash that the sector buffer can store more data, step 664. When enough space is made for a full packet of flash data in the sector buffer, step 658, and the host is not in the sleep mode, step 660, then the ExpressCard with EUSB accepts one packet of data, which is written into its sector buffer, step 670. The flow then continues with FIG. 19B.

However, when the host is still in the sleep mode, step 660, then the ExpressCard with EUSB sends a ready RDY signal to the host, step 668. The ready signal causes the host to wake up from its sleep mode. Since the host has already suspended the current OUT transfer, step 666, the host can re-start the current OUT transfer from step 654 with another OUT packet. However, this time the sector buffer should have enough space to accept the data packet, and steps 658, 660 will pass, allowing the data from the host to be immediately written into the sector buffer, step 670.

In FIG. 19B, after the first packet has been received from the host in step 670, the ExpressCard with EUSB checks the data packet for errors, such as by generating a CRC, step 672. ECC code may also be used with error correction of small errors such as 1-bit errors. When the CRC or ECC is good, step 674, then the ExpressCard with EUSB sends an acknowledgement ACK to the host, step 690. The host decrements the bytes transfer count by the number of bytes received, step 676. When the byte count reaches zero, step 686, the transfer is completed, step 688. Otherwise, the host sends, and the ExpressCard with EUSB sends the next data packet, using the flow from step 656 of FIG. 19A.

When the CRC or ECC is bad, step 674, and the timeout has elapsed, step 678, then the host suspends the current OUT transfer, step 680. When timeout has not yet elapsed, step 678, the ExpressCard with EUSB sends a not-acknowledge NACK to the host, step 682, since the received data had an error. The host re-sends the current data packet, step 684, and the flow continues from step 656 of FIG. 19A.

Although the present invention has been explained in relation to its preferred embodiment, it is to be understood that many other possible modifications and variations can be made without departing from the spirit and scope of the invention as hereinafter claimed.

What is claimed is:

1. An ExpressCard having universal serial bus (USB) connection, comprising:
a card case, which has two opposite first and second end portions and two opposite lateral portions;
a card connector, which is formed at the first end portion of the card case and has a USB interface;
one or more flash chips, which are implemented in the card case;
a USB flash controller, which is implemented in the card case and connected between the USB interface and the one or more flash chips in order to provide a data access to the one or more flash chips through the USB interface; and
a USB socket, which is implemented in the card case and connected to the USB flash controller in order to provide a data access to the one or more flash chips therethrough.

2. The ExpressCard as claimed in claim 1, wherein the USB socket is a mini-connector-type socket.

3. The ExpressCard as claimed in claim 1, wherein the USB socket is an extended mini-connector-type USB socket connected to a host for data transfer with which the host initiates a transfer by sending an IN request to the ExpressCard; the ExpressCard receives the IN request and sends an acknowledgement back to the host to acknowledge the IN request; the ExpressCard starts reading requested data and sending the data when available; when the ExpressCard is not yet ready to send data to the host, the ExpressCard asserts a not yet signal to the host; and when the ExpressCard is ready to send data, the ExpressCard asserts a ready signal to the host and de-asserts the not yet signal.

4. The ExpressCard as claimed in claim 1, wherein the USB socket is an extended mini-connector-type USB socket connected to a host for data transfer with which the host initiates a transfer by sending an OUT request to the ExpressCard; the ExpressCard receives the OUT request and sends an acknowledgement back to the host to acknowledge the OUT request; the ExpressCard starts receiving and buffering requested data; when the ExpressCard is not yet ready to receive more data from the host, the ExpressCard asserts a not yet signal to the host; when the ExpressCard is ready to receive data, the ExpressCard asserts a ready signal to the host and de-asserts the not yet signal signal.

5. The ExpressCard as claimed in claim 1, further comprising a switch, which is connected with the USB flash controller, the USB interface and USB socket in order to switch the USB flash controller to the USB interface or the USB socket.

6. The ExpressCard as claimed in claim 5, wherein the USB socket comprises a detection pin to determine that the switch switches the USB flash controller to the USB interface or the USB socket.

7. The ExpressCard as claimed in claim 6, wherein the USB socket is a mini-connector-type socket.

8. The ExpressCard as claimed in claim 6, wherein the USB socket is an extended mini-connector-type USB socket connected to a host for data transfer with which the host initiates a transfer by sending an IN request to the ExpressCard; the ExpressCard receives the IN request and sends an acknowledgement back to the host to acknowledge the IN request; the ExpressCard starts reading requested data and sending the data when available; when the ExpressCard is not yet ready to send data to the host, the ExpressCard asserts a not yet signal to the host; and when the ExpressCard is ready to send data, the ExpressCard asserts a ready signal to the host and de-asserts the not yet signal.

9. The ExpressCard as claimed in claim 6, wherein the USB socket is an extended mini-connector-type USB socket connected to a host for data transfer with which the host initiates a transfer by sending an OUT request to the ExpressCard; the ExpressCard receives the OUT request and sends an acknowledgement back to the host to acknowledge the OUT request; the ExpressCard starts receiving and buffering requested data; when the ExpressCard is not yet ready to receive more data from the host, the ExpressCard asserts a not yet signal to the host; when the ExpressCard is ready to receive data, the ExpressCard asserts a ready signal to the host and de-asserts the not yet signal.

10. The ExpressCard as claimed in claim 1, further comprising:
a power switch, which is connected between a USB interface power source of the card connector and a USB cable power line of the USB socket in order to switch the USB flash controller and the flash chips to the USB interface power source or the USB cable power line; and
a data switch, which is connected with the USB flash controller, the USB interface and the USB socket in order to switch the USB flash controller to the USB interface of the card connector or an USB cable data line of the USB socket according to an interface/cable data switching signal produced by the power switch.

11. An ExpressCard having USB connection, comprising:
a card case, which has two opposite first and second end portions and two opposite lateral portions;
a card connector, which is formed at the first end portion of the card case and has a PCI express serial interface and a USB interface;
one or more flash chips, which are implemented in the card case;
a PCI express and USB flash controller, which is implemented in the card case and connected between the PCI express serial interface and USB interface and the one or more flash chips in order to provide a data access to the one or more flash chips through the PCI express serial interface or the USB interface;
a USB socket, which is implemented in the card case and connected with the PCI express and USB flash controller in order to provide a data access to the one or more flash chips therethrough; and
a switch, which is connected with the PCI express and USB flash controller, the USB interface and the USB socket in order to switch the PCI express and USB flash controller to the USB interface or the USB socket.

12. The ExpressCard as claimed in claim 11, wherein the USB socket comprises a detection pin to determine that the switch switches the PCI express and USB flash controller to the USB interface or the USB socket.

13. The ExpressCard as claimed in claim 12, wherein the USB socket is a mini-connector-type socket.

14. The ExpressCard as claimed in claim 11, wherein the USB socket is an extended mini-connector-type USB socket connected to a host for data transfer with which the host initiates a transfer by sending an IN request to the ExpressCard; the ExpressCard receives the IN request and sends an acknowledgement back to the host to acknowledge the IN request; the ExpressCard starts reading requested data and sending the data when available; when the ExpressCard is not yet ready to send data to the host, the ExpressCard asserts a not yet signal to the host; and when the ExpressCard is ready to send data, the ExpressCard asserts a ready signal to the host and de-asserts the not yet signal.

15. The ExpressCard as claimed in claim 11, wherein the USB socket is an extended mini-connector-type USB socket connected to a host for data transfer with which the host initiates a transfer by sending an OUT request to the ExpressCard; the ExpressCard receives the OUT request and sends an acknowledgement back to the host to acknowledge the OUT request; the ExpressCard starts receiving and buffering requested data; when the ExpressCard is not yet ready to receive more data from the host, the ExpressCard asserts a not yet signal to the host; when the ExpressCard is ready to receive data, the ExpressCard asserts a ready signal to the host and de-asserts the not yet signal.

16. An ExpressCard having USB connection, comprising:
a card case, which has two opposite first and second end portions and two opposite lateral portions;
a card connector, which is formed at the first end portion of the card case and has a PCI express serial interface;
one or more flash chips, which are implemented in the card case;
a PCI express and USB flash controller, which is implemented in the card case and connected to the PCI express serial interface in order to provide a data access to the one or more flash chips through the PCI express serial interface; and
a USB socket, which is implemented in the card case and connected to the PCI express and USB flash controller in order to provide a data access to the one or more flash chips therethrough, wherein the PCI express and USB flash controller is based on a detection pin of the USB socket to determine the USB socket to be enabled or not.

17. The ExpressCard as claimed in claim 16, wherein the USB socket is a mini-connector-type socket.

18. The ExpressCard as claimed in claim 16, wherein the USB socket is an extended mini-connector-type USB socket connected to a host for data transfer with which the host initiates a transfer by sending an IN request to the ExpressCard; the ExpressCard receives the IN request and sends an acknowledgement back to the host to acknowledge the IN request; the ExpressCard starts reading requested data and sending the data when available; when the ExpressCard is not yet ready to send data to the host, the ExpressCard asserts a not yet signal to the host; and when the ExpressCard is ready to send data, the ExpressCard asserts a ready signal to the host and de-asserts the not yet signal.

19. The ExpressCard as claimed in claim 16, wherein the USB socket is an extended mini-connector-type USB socket connected to a host for data transfer with which the host initiates a transfer by sending an OUT request to the ExpressCard; the ExpressCard receives the OUT request and sends an acknowledgement back to the host to acknowledge the OUT request; the ExpressCard starts receiving and buffering requested data; when the ExpressCard is not yet ready to receive more data from the host, the ExpressCard asserts a not yet signal to the host; when the ExpressCard is ready to receive data, the ExpressCard asserts a ready signal to the host and de-asserts the not yet signal.

20. An ExpressCard having USB connection, comprising:
a card case, which has two opposite first and second end portions and two opposite lateral portions;
a card connector, which is formed at the first end portion of the card case and has a PCI express serial interface and a USB interface;
one or more flash chips, which are implemented in the card case;
a PCI express and USB flash controller, which is implemented in the card case and connected between the PCI express serial interface and USB interface and the one or more flash chips in order to provide a data access to the one or more flash chips through the PCI express serial interface or the USB interface;
a USB socket, which is implemented in the card case and connected to the PCI express and USB flash controller in order to provide a data access to the one or more flash chips therethrough;
a power switch, which is connected between a USB interface power source of the card connector and a USB cable power line of the USB socket in order to switch the PCI express and USB flash controller and the flash chips to the USB interface power source or the USB cable power line; and
a data switch, which is connected with the USB flash controller, the USB interface and the USB socket in order to switch the PCI express and USB flash controller to the USB interface of the card connector or an USB cable data line of the USB socket according to an interface/cable data switching signal produced by the power switch.

21. An ExpressCard having USB connection, comprising:
a card case, which has two opposite first and second end portions and two opposite lateral portions;
a card connector, which is formed at the first end portion of the card case and has a PCI express serial interface;
a functional device, which is implemented in the card case, wherein the functional device is a communication processor, a media processor or a bus bridge;
a PCI express interface and USB interface controller, which is implemented in the card case and connected to the PCI express serial interface in order to provide a data access to the communication or media processor or bus bridge through the PCI express serial interface; and
a USB socket, which is implemented in the card case and connected to the PCI express interface and USB interface controller in order to provide a data access to the communication or media processor or bus bridge therethrough, wherein the PCI express interface and USB interface controller is based on a detection pin of the USB socket to determine the USB socket to be enabled or not.
